(19) United States
(12) Patent Application Publication
(10) Pub. No.: US 2011/0213519 A1
(43) Pub. Date: Sep. 1, 2011

(54) METHOD AND DEVICE FOR OPERATING A HYBRID DRIVE FOR A VEHICLE

(76) Inventor: Thomas Huber, Daisbach (DE)

(21) Appl. No.: 12/998,104

(22) PCT Filed: Aug. 13, 2009
(86) PCT No.: PCT/EP2009/060485

§ 371 Date: May 19, 2011

(30) Foreign Application Priority Data
Sep. 16, 2008 (DE) 10 2008 042 132.4

(51) Int. Cl. G06F 19/00

(52) U.S. Cl. 701/22; 180/65.21; 903/902

(57) ABSTRACT

In a method for operating a hybrid drive for a vehicle, in which a first drive unit drives a first axle of the vehicle, while a second drive unit drives a second axle of the vehicle, both drive units jointly determining the power of the vehicle, all possible transmission ratios of the first drive unit connected to a first transmission and of the second drive unit (9) connected to a second transmission are determined for optimal power distribution for the vehicle. In addition, a quality criterion for the transmission ratios and torques for the first and the second drive units are determined for all combinations of transmission ratios as a function of a driver's intent.

### BACKGROUND OF THE INVENTION

1. Field of the Invention

The present invention relates to a method for operating a hybrid drive for a vehicle, in which a first drive unit drives a first axle of the vehicle while a second drive unit drives a second axle of the vehicle, both drive units jointly determining the power of the vehicle, as well as a method for carrying out the method.

2. Description of Related Art

Vehicles having hybrid drives in which various drives are utilized for a drive task are being developed with growing intensity. The individual motors in the hybrid drive may work together differently. They either operate simultaneously, or only one drive unit acts on the vehicle that is to be moved.

In the case of the so-called parallel hybrids, there is an electric drive on the shaft of an internal combustion engine. A method for determining a power distribution factor for such a vehicle, in which both drive units make a contribution to the power of the vehicle, is known from published German patent application document DE 103 23 722 A1. In this method a cost function that depends on the power distribution factor is minimized. By determining the minimum of the cost function, such a power distribution factor for which the lowest fuel consumption is needed is ascertained.

Besides the parallel hybrid vehicles, hybrid concepts are known which have a separately electrically driven vehicle axle.

### BRIEF SUMMARY OF THE INVENTION

The method according to the present invention for operating a vehicle having a hybrid drive having the features of claim 1 has the advantage that power distribution is optimal in axle hybrid concepts. To distribute the power of the vehicle, all possible transmission ratios of the first drive unit connected to a first transmission and of the second drive unit connected to a second transmission are determined, a quality criterion for the transmission ratios and torques for the first and second drive units being determined for all combinations of transmission ratios of the two transmissions, as a function of a driver's intent. Using the algorithm, parameters are generated simultaneously for the setpoint torques of the two drive units present, as well as parameters for the transmission ratio relationships of the two transmissions. That makes it possible to dispense with prior determination of a rotational speed of the drive units.

In a refinement of the present invention, the transmission ratios for both transmissions assigned to the drive units, with the respective associated quality criterion and the torques for the first and second drive units, are stored in a table which is used to control and/or regulate the drive units. When a change occurs in the driver's intent, in the vehicle velocity, in the electrical energy required by the vehicle when using an electric motor as a drive unit or in the charge state of the traction battery, the transmission ratio relationships of the two transmissions and the setpoint torques of the two drive units may be read out of the table and set at the drive units, so that an optimal power distribution between the two drive units exists at any point in time. Using the transmission ratios, conclusions about the rotational speed of the drive units of the vehicle are possible at any time.

Advantageously, the setpoint transmission ratios of the first and second drive units are read out of the table on the basis of the quality criterion having the lowest value. With the aid of the quality criterion, the best combination of transmission ratios is determined from the table, which enables the most fuel-efficient drive of the vehicle in terms of energy technology.

In one embodiment, the setpoint transmission ratios thus ascertained are conveyed to a transmission control unit, which checks the setpoint transmission ratios on the basis of the instantaneous drive conditions and sets actual transmission ratios corresponding to the instantaneous drive conditions at the transmissions of the two drive units. This ensures that the best transmission ratios, from the perspective of the transmission control unit, are always set.

When there is a difference between the transmission ratios set by the transmission control unit and the setpoint transmission ratios from the table, there is assurance in any case that aspects which were given no attention when determining the setpoint transmission ratios have also been taken into account.

When the actual transmission ratios agree with the ascertained setpoint transmission ratios, the torques stored in the table for the setpoint transmission ratios are set at the two drive units, and thus the optimal power distribution of the two drive units is attained.

Alternatively, if the setpoint transmission ratios do not agree with the actual transmission ratios set by the transmission control unit, the torques belonging to the actual transmission ratios are read out of the table on the basis of the actual transmission ratios for the transmissions of both drive units and are set at the drive units. This is possible, since the transmission control unit reports back which transmission ratios it has actually set. A free setting option of this sort is reserved for the transmission control unit, in order to ensure that the optimal power distribution between the two drive units is always implemented.

Advantageously, at a transmission of one drive unit the ascertained setpoint transmission ratio is set, while the transmission ratio for the other transmission of the other drive unit is determined as a function of the driver's intent and/or the vehicle velocity and/or the transmission ratio set at the transmission, and/or the setpoint torque that correlates with the setpoint transmission ratio set at the transmission of the drive unit. The method according to the present invention thus also takes into account that only one ascertained setpoint transmission ratio has proven to be optimal. The setpoint torque for this setpoint transmission ratio is taken from the table, while the setpoint torque for the other drive unit must be calculated, since only in this way may an optimal power distribution between the two drive units be attained.

In a particularly advantageous embodiment, the optimal power distribution is achieved by determining the value of the quality criterion as a function of the fuel utilization of the first drive unit designed as an internal combustion engine and the electrical energy of the second drive unit designed as an electric motor. Since it is possible to ascertain the rotational speeds of the internal combustion engine and the electric motor from the combination of transmission ratios on the basis of the driving speed, it is possible with the aid of these rotational speeds and the driver's intent to establish the value of the quality criterion, which for example weighs the electrical energy expended by the electric motor and the fuel used by the internal combustion engine against each other.

The possibility also exists, however, that the value of the quality criterion is determined as a function of the pollutant emission generated by the first drive unit designed as an internal combustion engine. But it could also thus be established that under given conditions purely electric driving represents a better alternative than the joint drive of the vehicle by the internal combustion engine and the electric motor.

In one embodiment, the possible transmission ratios for the first transmission of the first drive unit and for the second transmission of the second drive unit are limited, by eliminating during a predefined vehicle velocity those transmission ratios which cause an overshooting or undershooting of a rotational speed threshold and/or an overshooting or undershooting of a torque threshold. This prevents, at the instantaneous vehicle velocity, a drive unit from being operated outside of its permissible operating range due to the choice of a transmission ratio in terms of both rotational speed and torque.

In another refinement of the present invention, a device for operating a hybrid drive for a vehicle is provided, in which a first drive unit drives a first axle of the vehicle, while a second drive unit drives a second axle of the vehicle, both drive units jointly determining the power of the vehicle.

In order to set an optimal power distribution of the drive units in axle hybrid concepts, all possible transmission ratios of the first drive unit connected to a first transmission and of the second drive unit connected to a second transmission are determined, means being present which, for all combinations of transmission ratios of the two transmissions, determine a quality criterion for the transmission ratios and torques for the first and second drive units as a function of a driver's intent. This device has the advantage of simultaneously determining the respective transmission ratios and of determining the setpoint torques for the drive units.

In one embodiment of the present invention, an engine control unit of the first drive unit ascertains the combinations of the transmission ratios, the quality criterion, and the torques for the first and second drive units and stores them in a table. This table advantageously contains all possible combinations of transmission ratios to which the particular setpoint torque of the individual drive units is assigned.

The engine control unit of the first drive unit is connected to an accelerator sensor to ascertain the driver's intent, and at the same time leads to a transmission control unit to which the engine control unit conveys the setpoint transmission ratios of both drive units, which the engine control unit of the first drive unit has read out of the table, as a function of the best quality criterion. By using the control units which are already present in the vehicle, it is possible to ascertain the power distribution of the two drive units economically without additional expense for hardware.

The transmission control unit examines the conveyed setpoint transmission ratios as a function of the instantaneous drive situation of the vehicle, and reports the actually set transmission ratios back to the engine control unit of the first drive unit. This ensures that the transmission control unit maintains priority over the setting of the transmission ratios at the two transmissions, in order to ensure that all conditions arising from the instantaneous drive situation of the vehicle are taken into account.

In one embodiment, the engine control unit selects the applicable setpoint torques from the table on the basis of the actual transmission ratios reported by the transmission control unit, and forwards them to the drive units. Because of this finely tuned selection of the setpoint torques, the optimal power distribution at the two drive units is always attained.

### BRIEF DESCRIPTION OF THE DRAWINGS

FIG. 1 shows a schematic diagram of a hybrid concept having a separately electrically driven axle.

FIG. 2 shows a schematic flow chart of one exemplary embodiment of the method according to the present invention.

### DETAILED DESCRIPTION OF THE INVENTION

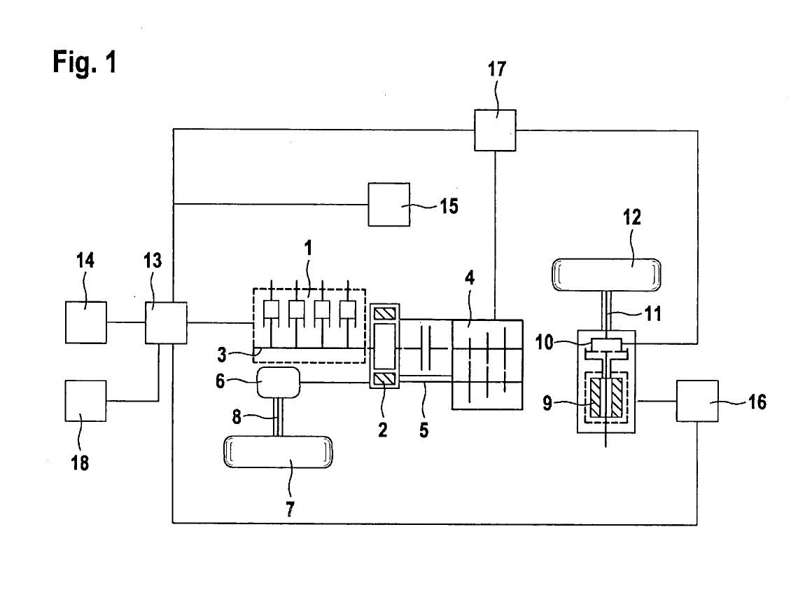

According to FIG. 1, an internal combustion engine 1 and a first electric motor 2 are situated on drive shaft 3 of internal combustion engine 1. First electric motor 2 leads to a first transmission unit 4, which is connected via drive shaft 5 to a differential 6, which passes the torque on to an axle 8 to which a wheel 7 is attached.

A second electric motor 9 is mounted with a second transmission unit 10 on a second axle 11 of the vehicle, the torque generated by second electric motor 9 being passed on to a wheel 12 which is driven by second axle 11.

Internal combustion engine 1 is connected to an engine control unit 13, via which the processes in internal combustion engine 1 are controlled and regulated. Engine control unit 13 receives signals from a plurality of sensors, of which only the performance sensor 14, which is connected to an accelerator pedal operated by the vehicle driver, and a rotational speed sensor 18 for ascertaining the vehicle velocity, are depicted in the present example.

In addition, first electric motor 2 is connected to a first electric motor control unit 15, while second electric motor 9 is connected to a second electric motor control unit 16. The two transmission units 4 and 10 lead to a shared transmission control unit 17. Engine control unit 13 is connected to transmission control unit 17, as well as to first electric motor control unit 15 and second electric motor control unit 16.

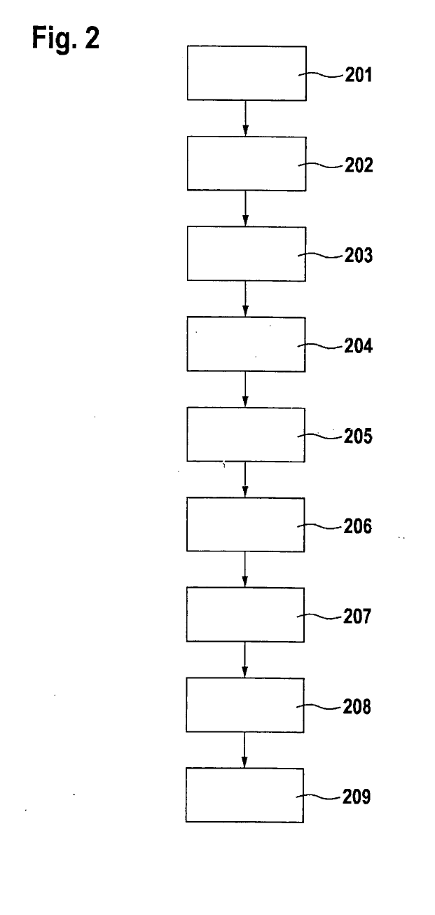

On the basis of FIG. 2, one possible specific embodiment of the present invention will now be explained, with the aid of which an optimal power distribution between internal combustion engine 1 and second electric motor 9 is set. The optimal power distribution is ascertained in this example with the aid of engine control unit 13.

The driver's intent and the vehicle velocity are determined in block 201. The driver's intent is characterized by a positive or negative acceleration, which is predefined by the position of operating pedal 14. Operating pedal 14 in this case may be an accelerator pedal or a brake pedal. Based on the position of the accelerator pedal and/or the position of the brake pedal as well as the instantaneous vehicle velocity, which has been determined by rotational speed sensor 18, the power intended by the driver for propelling the vehicle is ascertained.

In next block 202, all possible transmission ratios for each of transmissions 4 and 10 are determined. For each transmission 4, 10, first the rotational speeds and then the torques that are transmitted to internal combustion engine 1 and to electric motor 9 are considered. If a transmission ratio results in overshooting an applicable rotational speed threshold (maximum rotational speed) of internal combustion engine 1 or of second electric motor 9, this transmission ratio is no longer considered in the further course of determining the power distribution between internal combustion engine 1 and electric motor 9. The same procedure is used with transmission ratios that result in undershooting a rotational speed threshold (minimum rotational speed). As an example of this measure, let it be stated here that the transmission ratios representing the first and the second gears are excluded from further consideration when the vehicle velocity is 130 km/h.

Comparable consideration is given to the torques of internal combustion engine 1 and of second electric motor 9 which are responsible for the power that propels the vehicle. Transmission ratios that result in undershooting or overshooting of applicable torque thresholds are also not considered further. These torque thresholds depend, for example, on minimum or maximum torques, or an intended torque reserve. For example, if a driving power which is delivered by a fifth gear is not sufficient to implement the driver's intent, a transmission ratio of the fourth gear is set, with which the intended drive is attained. The transmission ratio of the fifth gear is now excluded from further consideration.

After the exclusion of the transmission ratios ascertained in block 202 but not usable further, all remaining transmission ratios of transmissions 4 and 10 are combined with each other in block 203. In block 204, the rotational speeds for internal combustion engine 1 and second electric motor 9 are determined for each remaining combination of transmission ratios of transmissions 4 and 10, using the instantaneous vehicle velocity. With the aid of these rotational speeds and the driver's intent, the value of a quality criterion is ascertained in block 205 using the method known per se from published German patent application document DE 10 2005 044 268 A1. In this case the quality criterion represents a cost function for the energy consumption or the emissions, whereby the power distribution between internal combustion engine 1 and second electric motor 9 is controlled or regulated. By applying this method, both the optimal torques for second electric motor 9 and internal combustion engine 1 and the value of the quality criterion at the optimal torque distribution are calculated. For each combination of transmission ratios of transmissions 4 and 10, the corresponding setpoint torques for internal combustion engine 1, first electric motor 2 and second electric motor 9, as well as the quality criterion determined for the optimal torque distribution, are saved in a table.

In block 206, the optimal combination for the transmission ratios of transmissions 4 and 10 are determined from the table. To that end, the quality criterion having the lowest value is selected from the table. The corresponding transmission ratios are considered to be the setpoint transmission ratios for transmissions 4 and 10. The setpoint transmission ratios thus ascertained are conveyed from engine control unit 13 to transmission control unit 17 in block 207. Transmission control unit 17 decides whether it is possible to set the conveyed setpoint transmission ratios, and after checking the instantaneous operating situation of transmissions 4 and 10 sets actual transmission ratios. These actual transmission ratios are transmitted to engine control unit 13 in block 208.

In block 209, engine control unit 13 checks whether the settings for the actual transmission ratios agree with the setpoint transmission ratios. If this is the case, the optimal torques belonging in the table to the setpoint transmission ratios are read out. Engine control unit 13 sets the optimal torque thus ascertained at internal combustion engine 1, and conveys to second electric motor control unit 16 the optimal torque for second electric motor 9, which is set at the latter by second electric motor control unit 16.

But if the setpoint transmission ratios differ from the actual transmission ratios set by transmission control unit 17, engine control unit 13 reads from the table the torques belonging to the combination of the actual transmission ratios, which are set at internal combustion engine 1 and second electric motor 9 in the manner just described.

If it turns out when comparing the setpoint transmission ratios with the actual transmission ratios that it was only possible to set the ascertained optimal setpoint transmission ratio at one transmission 4, the torque associated with this one drive unit 1 is read out of the table and set at drive unit 1. The setpoint torque for the other drive unit 9 is then calculated from the driver's intent, the vehicle velocity, the set transmission ratio and the setpoint torque of first drive unit 1.

1-15. (canceled)

16. A method for operating a hybrid drive for a vehicle, comprising:
driving a first axle of the vehicle with a first drive unit, wherein the first drive unit is connected to a first transmission;
driving a second axle of the vehicle with a second drive unit, wherein the second drive unit is connected to a second transmission, and wherein both the first and second drive units jointly determine the power of the vehicle;
determining, for power distribution, all possible transmission ratios of the first drive unit connected to the first transmission and of the second drive unit connected to the second transmission; and
determining a quality criterion for the transmission ratios and torques for the first and second drive units for all combinations of transmission ratios of the first and second transmissions as a function of a driver's intent.

17. The method as recited in claim 16, wherein the transmission ratios of the first and second transmissions, along with the respective associated quality criterion and the torques for the first and second drive units, are stored in a table used to control the first and second drive units.

18. The method as recited in claim 17, wherein setpoint transmission ratios of the first and second drive units are stored in the table, and wherein the setpoint transmission ratios are read out of the table on the basis of the quality criterion having the lowest value.

19. The method as recited in claim 18, wherein the setpoint transmission ratios are read out of the table and transmitted to a transmission control unit, and wherein the transmission control unit (i) checks the setpoint transmission ratios on the basis of instantaneous drive conditions, and (ii) sets actual transmission ratios corresponding to the instantaneous drive conditions in the first and second transmissions of the first and second drive units.

20. The method as recited in claim 19, wherein when the actual transmission ratios set by the transmission control unit agree with the setpoint transmission ratios, torques stored in the table for the setpoint transmission ratios are set at the first and drive units.

21. The method as recited in claim 19, wherein when the setpoint transmission ratios do not agree with the actual transmission ratios set by the transmission control unit, torques stored in the table for the actual transmission ratios are read out of the table and are set at the first and second drive units.

22. The method as recited in claim 21, wherein the setpoint transmission ratio is set at one of the first transmission of the first drive unit and the second transmission of the second drive unit, and wherein the transmission ratio for the other one of the first transmission and the second transmission is determined as a function of at least one of the driver's intent, vehicle velocity, and the setpoint torque which correlates with the setpoint transmission ratio set at the other one of the first transmission and the second transmission.

23. The method as recited in claim 17, wherein the value of the quality criterion is determined as a function of the fuel used by the first drive unit and the electrical energy of the second drive unit, wherein the first drive unit is an internal combustion unit and the second drive unit is an electric motor.

24. The method as recited in claim 17, wherein the value of the quality criterion is determined as a function of the pollutant emission generated by the first drive unit, wherein the first drive unit is an internal combustion engine.

25. The method as recited in claim 16, wherein the possible transmission ratios for the first transmission of the first drive unit and for the second transmission of the second drive unit are limited by eliminating, at a predefined vehicle velocity, transmission ratios which cause one of an overshoot or undershoot of at least one of a rotational speed threshold and a torque threshold.

26. A control device for operating a hybrid drive of a vehicle having a first drive unit driving a first axle of the vehicle and a second drive unit driving a second axle of the vehicle, both the first and second drive units jointly determining the power of the vehicle, the control device comprising:
a control unit configured to:
determine, for power distribution, all possible transmission ratios of the first drive unit connected to the first transmission and of the second drive unit connected to the second transmission;
determine, for all combinations of transmission ratios of the first and second transmissions, a quality criterion for the transmission ratios and torques for the first and second drive units as a function of a driver's intent.

27. The device as recited in claim 26, wherein the control unit is an engine control unit of the first drive unit, and wherein the combinations of the transmission ratios, the quality criterion, and the torques for the first and second drive units are saved in a table.

28. The device as recited in claim 27, further comprising:
an accelerator sensor configured to determine the driver's intent; and
a transmission control unit;
wherein the engine control unit of the first drive unit is connected to the accelerator sensor to determine the driver's intent, and wherein the engine control unit of the first drive unit transmits to the transmission control unit setpoint transmission ratios read out of the table as a function of the best quality criterion.

29. The device as recited in claim 28, wherein the transmission control unit is configured to:
check the received setpoint transmission ratios as a function of the instantaneous driving situation of the vehicle; and
transmit the actual transmission ratios back to the engine control unit of the first drive unit.

30. The device as recited in claim 29, wherein the engine control unit is configured to:
select optimal setpoint torques from the table on the basis of the actual transmission ratios received from the transmission control unit and forward the optimal setpoint torques to the first and second drive units.
